(19) United States
(12) Patent Application Publication
(10) Pub. No.: US 2006/0260696 A1
(43) Pub. Date: Nov. 23, 2006

(54) Fuel delivery and vapor control system

(75) Inventors: Pascal Leymarie, Chalons en Champagne (FR); Jean Philippe Verriere, Bouzy (FR); Humbert de Monts de Savasse, Reims (FR)

Correspondence Address: REISING, ETHINGTON, BARNES, KISSELLE, P.C., P O BOX 4390, TROY, MI, 48099-4390, US

(73) Assignee: TI Automotive Fuel Systems SAS

(21) Appl. No.: 11/412,639

(22) Filed: Apr. 27, 2006

(30) Foreign Application Priority Data
Apr. 27, 2005 (FR) 05 04255

(51) Int. Cl. F02M 37/04; B01D 47/00; B67D 5/40

(52) U.S. Cl. 137/565.17; 123/509; 123/576; 137/565.37

(57) ABSTRACT

An assembly received at least in part in a fuel tank includes first and second fuel system components each adapted to be disposed at least partially in a fuel tank, and a connection feature interconnecting the first and second components. The connection feature permits relative movement between the first and second components which may, for example, facilitate insertion of both the first and second components into the fuel tank as a single unit and through a common opening in the fuel tank.

### TECHNICAL FIELD

The present invention relates generally to vehicle fuel systems and more particularly to a fuel pumping assembly and accessories.

### BACKGROUND OF THE INVENTION

Vehicles with engines using combustible hydrocarbon fuels are well known. Some fuel systems utilize fuel pumps disposed in a vehicle fuel tank to deliver fuel under pressure from the fuel tank to the engine. Often, fuel level gauges are also disposed in the fuel tank to provide an indication of the level of fuel in the fuel tank. Still further, fuel vapor vent valves, fuel pressure regulators, and fuel filters may be disposed in a vehicle fuel tank. Such components take up space in the fuel tank and their size is limited by the need to install them through an opening into the fuel tank, and mount and retain them within the fuel tank.

Also, the emission to the atmosphere of environmentally unfriendly hydrocarbon fuel vapors is being increasingly regulated by various governments and agencies. One way to limit the emission of fuel vapors to the atmosphere is with a fuel vapor storage device which may include activated carbon or charcoal material. The storage device preferably removes hydrocarbons from the vapor and may be communicated with a vehicle engine to deliver fuel vapor to the engine for combustion in the engine.

Fuel vapor storage devices have been housed outside of a vehicle fuel tank, and their size, and hence their storage capacity, has been limited by the space available in the vehicle. This arrangement also requires external fittings and connections that increase assembly burden and the potential for vapor emission to the atmosphere (e.g. from vapor lines and their connections being exposed outside of the fuel tank).

### SUMMARY OF THE INVENTION

An assembly received at least in part in a fuel tank includes first and second fuel system components each adapted to be disposed at least partially in a fuel tank, and a connection feature interconnecting the first and second components. The connection feature permits relative movement between the first and second components which may, for example, facilitate insertion of both the fuel pump assembly and the accessory into the fuel tank as a single unit and through a common opening in the fuel tank.

In one presently preferred implementation, the combined size of the first and second components is greater than the size of an opening into the fuel tank through which the components are inserted into the fuel tank. To install the components into the fuel tank, the first component is inserted in a first direction at least partially through the opening and then moved at an angle to the first direction and relative to the opening to provide clearance for the second component to be inserted through the opening. The connection feature permits the second component to be moved linearly relative to the first component until the second component is also installed in the fuel tank to the desired extent. A flange may be connected to the second component and is preferably sealed to the fuel tank to close the opening and mount the first and second components to the tank.

In one implementation, the first component is a fuel pump module including a fuel pump and a canister associated with the fuel pump, and the second component is a filter. The second component may be a vapor storage device that includes a vapor control medium. The storage device, filter or other component may have a height that is substantially equal to the height of the fuel tank in the area of the opening. The storage device, filter or other component may have a cross-sectional area that is close to that of the fuel tank opening, and even, according to one implementation, more or less equal to that of the fuel tank opening.

### BRIEF DESCRIPTION OF THE DRAWINGS

These and other objects, features and advantages of the present invention will be apparent from the following detailed description of the preferred embodiments and best mode, appended claims and accompanying drawings in which:

FIG. 1 is a side view of one implementation of a fuel system assembly shown in a retracted position;

FIGS. 2, 3, 4, 5 and 6 represent successive stages of installation of this assembly into a fuel tank of the motor vehicle; and

FIG. 7 is a perspective view of an alternate fuel system assembly.

### DETAILED DESCRIPTION OF PREFERRED EMBODIMENTS

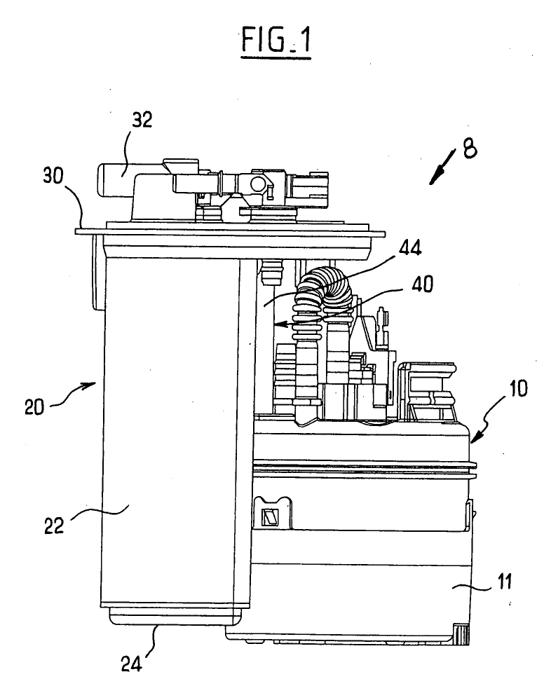

Referring in more detail to the drawings, FIG. 1 illustrates a fuel system assembly 8 having two fuel system components 10, 20 each adapted to be received at least partially in a fuel tank. The assembly includes a connection feature 40 preferably between the two components 10, 20 that permits relative movement of the components to, for example, facilitate insertion of the assembly 8 into the fuel tank. A first fuel system component 10 may include a fuel pumping assembly that takes in fuel from the tank and delivers it under pressure to support operation of an engine. The second fuel system component 20 may include a filter or other accessory. The filter may remove contaminants from the fuel before the fuel is pumped to the engine. The second component 20 may also or alternatively include a fuel vapor storage device adapted to at least temporarily store fuel vapors such as with a filter or vapor handling medium like activated carbon/charcoal.

The fuel system components 10, 20 can be of known construction and hence, their specific construction and operation will not be described herein. By way of a non-limiting example, the fuel pump may include a gerotor, turbine type or other pumping assembly driven by an electric motor. The vapor storage device and/or fuel filter can be constructed and arranged as set forth in U.S. Pat. No. 6,302,144, the disclosure of which is incorporated herein by reference in its entirety.

The pumping assembly 10 may include an electric pump designed to pump fuel under pressure from the tank 90 so that the fuel may be routed to the engine to support its operation. The pumping assembly 10 preferably includes a container or reservoir 11 that is communicated with the inlet of the fuel pump. The reservoir 11 maintains a volume of fuel around the intake of the pump so that fuel is essentially continuously available to be pumped to the engine, even when there is a relatively low volume of fuel in the main fuel tank and the vehicle is accelerating or traversing corners or inclinations which may cause the fuel in the tank to shift away from the fuel pump. The reservoir 11 may be filled from the fuel tank by any appropriate arrangement or device, including gravity feed or a jet pump, for example, fed by an outlet stage of the pump or fuel returned from and/or not used by the engine.

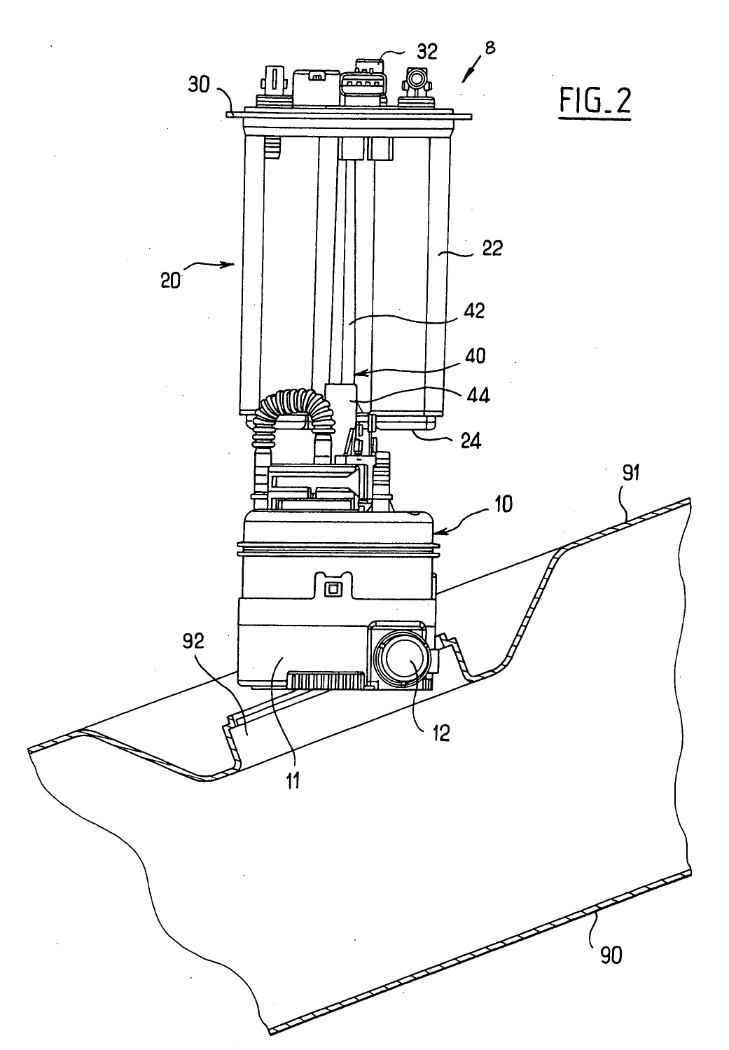

The pumping assembly 10 also may include filters placed upstream and downstream of the electric pump as well as a pressure regulator 12 (FIG. 2). Preferably, the assembly 10 also includes a fuel level sensor which is responsive to and provides a signal indicative of the level of fuel in the tank 90. Some fuel level sensors generally include a float placed on the end of a pivoted arm the position of which changes a signal generated from a resistive transducer. However, any suitable fuel level sensor may be used, so the construction and operation of the fuel level sensor will therefore not be described in detail.

The second component 20 preferably includes a fuel vapor storage device that includes a canister 22 which contains an amount of active charcoal. The canister 22 is communicated with the fuel tank so that hydrocarbon vapors released from fuel in the fuel tank flow across or through the active charcoal thereby trapping or absorbing the fuel vapors. The interior of the canister preferably is also communicated or associated with a fresh-air intake circuit designed to provide fresh air flow into and through the canister to recover the fuel vapors and route them to the engine. The canister 22 may also include a rollover valve that prevents liquid fuel from entering the canister should the vehicle overturn.

The fuel tank 90 can be of substantially any size and shape to fit in a desired area of the vehicle and carry a desired volume of fuel. It is preferably made from a thermoplastic material, and includes an access opening 92, typically in its upper wall 91. The access opening 92 may be generally circular. It is designed to be closed off during use by a complementary base, or flange 30 in the attached figures.

The flange 30 carries fittings 32 that provide the appropriate fluid connections to the engine, as well as a connector 34 providing the required electrical connection to the pump, and to the fuel level sensor. According to one presently preferred implementation shown in the attached figures, the second component 20 is carried by the flange 30.

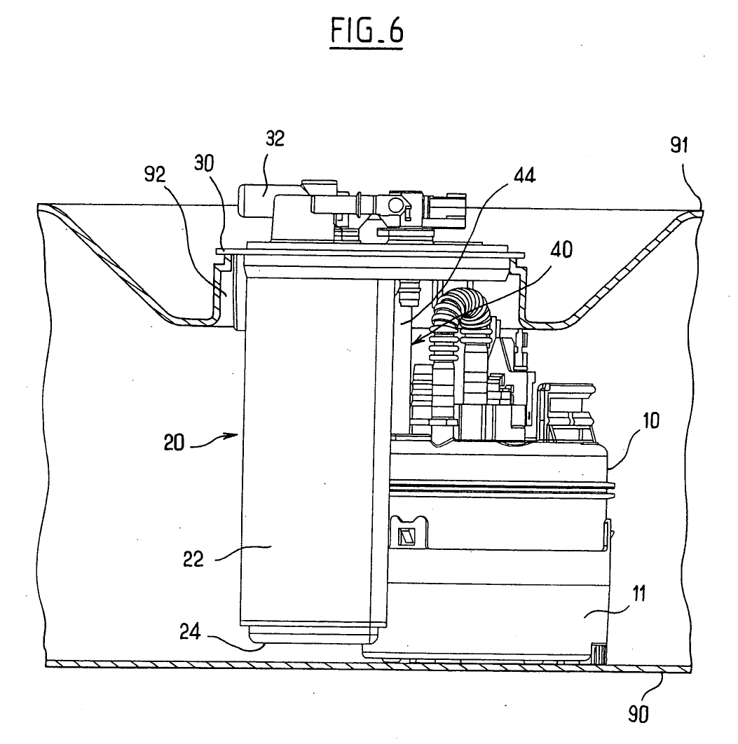

The canister 22 of this vapor storage device 20 has a maximum cross sectional area or dimension that is close to the effective area or dimension of the opening 92, and a height that may be more or less equal to that of the tank 90 in the area of the opening 92, as best illustrated in FIG. 6. Nevertheless, so that the canister can be received through the opening 92, the cross section of the canister 22 is at least slightly less than the area of the opening 92. The canister 22 may carry at least a portion of the connection feature or support 40 that is designed to interconnect and permit relative movement between the first component 10 and the second component 20 with the total dimensions of the canister 22 and of the associated portion of the support 40 being less than the cross section or effective area of the opening 92 in the tank 90.

In one implementation, the support 40 may include at least two elements 42, 44 that are capable of relative linear motion. These can be two telescopic or interconnected sliding elements which move relative to each other generally in the direction in which the assembly 8 is inserted into the fuel tank. One element 42 preferably is carried by the canister 22 or even the flange 30 attached to the canister 22, as in the form of a slide-rail created during molding of the canister 22, for example. The other element 44 may be attached to the pumping assembly 10, and may be created during molding, for example. The elements 40, 42 preferably are yieldably biased apart, such as by a spring or elastic member, so that the assembly normally is in its extended state, as shown in FIGS. 2-5. When the assembly is installed in the fuel tank 90, the first component 10 is yieldably biased against a bottom wall of the fuel tank 90. Desirably, where the first component is a fuel pumping assembly 10, this positions an inlet of the assembly near the bottom of the fuel tank 90.

There may be designed into the tank 90, such as on the bottom thereof, shapes such as bosses or ribs that are intended to hold one or both of the components 10, 20, especially in the event of lateral impact. These shapes preferably are designed to allow both retention of the components 10, 20, and installation of the pumping assembly 10 by sliding or other movement between the positions illustrated in FIGS. 2, 3, 4, and 5. The shapes suitable for the retention of the pumping module 10 can be formed, for example, as radial ribs or sliders in relation to the axis of the opening 92 and parallel to the sliding direction of the pumping module 10. Where appropriate, these shapes can be equipped with snap-fit resources mating with the pumping assembly 10 and/or the canister 22 of the vapor storage device 20, in order to reinforce the retention of the latter. These shapes be designed to be universal in the sense that they can also be used to secure a standard fuel pumping module 10, devoid of a vapor storage device 20, opposite to the opening 92, when the vehicle to be equipped is lacking this option.

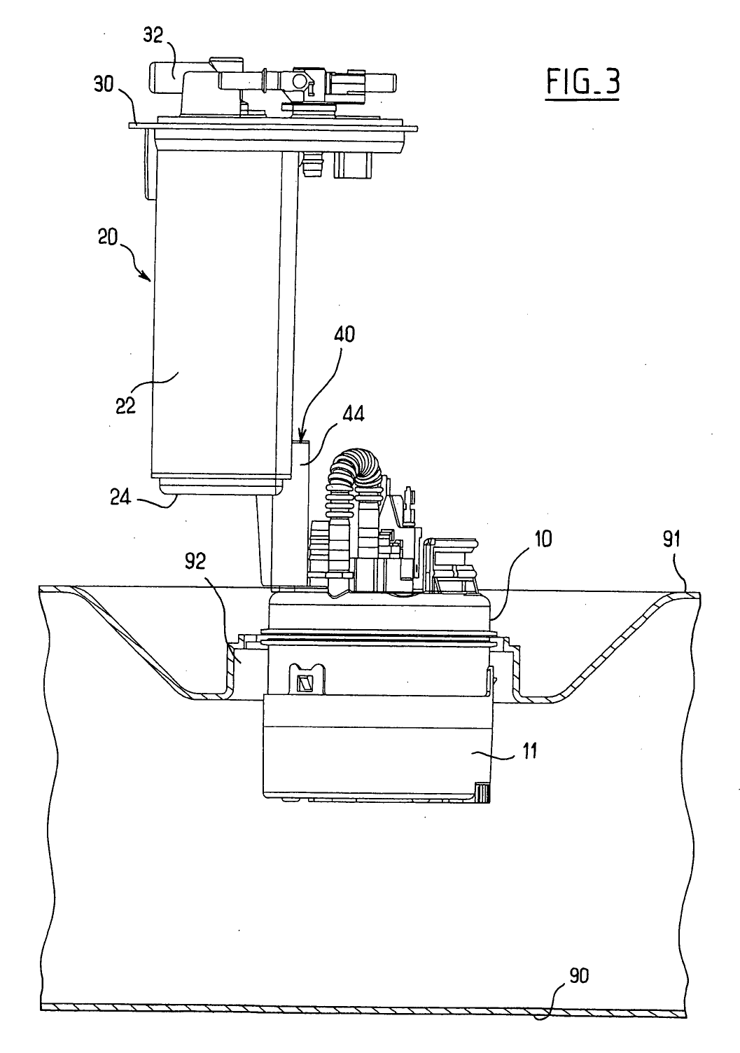

As illustrated in FIGS. 2 and 3, to install the pumping assembly 10 in the fuel tank 90, the pumping assembly 10 is presented in its extended position and an inclined manner in relation to the opening 92, and then, when the reservoir 11 of the pumping assembly 10 has entered the tank 90 through the opening 92, is lowered into the tank 90, preferably opposite to the opening 92. During this stage, represented in FIGS. 2 and 3, the second component 20 remains at least partially outside the tank 90 and has a portion that laterally overlies the fuel tank 90.

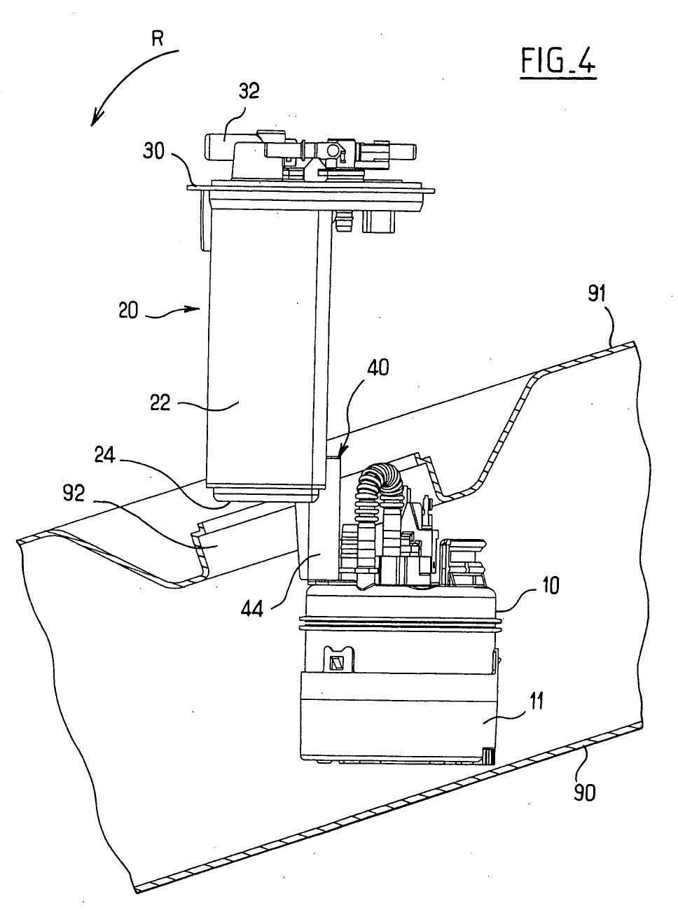

As shown in FIG. 4, the second component 20 is then presented in an inclined manner in relation to the opening 92, so that the second component 20 can, in turn, be inserted into the tank 90. As shown in FIG. 3, the dimension of the opening 92 is not sufficiently large in relation to the combined sideways or lateral dimension of the first and second components 10, 20. So that the canister 22 can enter into the tank 90 via the opening 92, a rotational movement, represented by arrow R, possibly accompanied by a sliding movement of the support 40 is effected until the bottom 24 of the canister 22 is inside the tank 90. This positions a portion of the first component 10 axially beneath the fuel tank relative to the axis of the opening 92 and laterally displaced from the opening 92 such that the first component would engage the fuel tank if the unit was moved axially in a direction to remove it from the fuel tank 90.

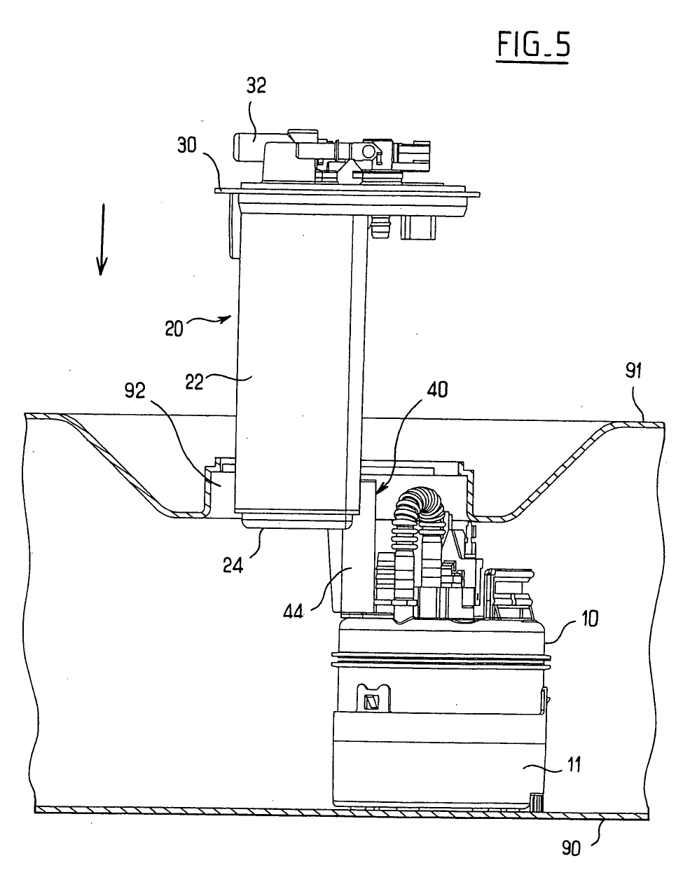

It then remains only, as shown in FIGS. 5 and 6, to compress the support 40 to lower the remainder of the assembly 8 including the second component 20 into the tank. Accordingly, the support 40 permits movement of the second component 20 relative to the first component in a direction substantially parallel to the axis of the opening and/or the general direction of insertion of the assembly 8 into the fuel tank (though the assembly may be tilted or otherwise manipulated during some or all of the installation process.) The flange 30 may then be secured onto the tank about the periphery of the opening 92. Accordingly, the first component or fuel pump assembly 10 is connected to the second component 20 via the support 40. The second component is, in turn, connected to the fuel tank 90 by the flange 30. Each component may have a desired size and capacity yet may be received as a single unit in the fuel tank 90 through an opening that is relatively small in comparison to the overall size of the assembly 8.

Accordingly, the size and capacity of the components 10, 20 can be optimized, because their size may correspond more or less to the height of the fuel tank 90 in the area of the opening 92, and to the effective area of the opening 92. According to one implementation, the maximum sectional area or lateral dimension of the canister 22 is more or less equal to the effective area of the opening 92.

In this implementation, since the vapor storage device 20 is placed inside the fuel tank 90, the risk of unwanted vapor leakage outside the tank is reduced or prevented, such as in the event of rupture of the canister 22, for example. By virtue of the location of the canister 22 inside the fuel tank, any complex or awkward geometry of the canister 22 is also avoided. Also, more of the vapor connections and vapor lines or conduits are disposed in the tank to help contain any vapor permeation or leakage therefrom.

Finally, one of ordinary skill in this art will appreciate the simplicity of assembly achieved using the assembly described herein. In fact, the assembly requires no fluid or electrical connection at the moment of installation. The assembly can be fully pre-assembled in the factory and easily installed in the fuel tank.

The assembly 8 can of course be disposed in its compressed or retracted position shown in FIG. 6 during storage and transportation. To this end, a catch or a part such as a pin could be placed on between or connecting the support elements 42, 44, allowing the assembly to be held in its compressed or retracted position shown in FIG. 1.

In addition, the canister 22 can be equipped with other components or accessories, like a vapor vent valve, for example, which is well known to the skilled persons, or with a solenoid-type ventilation valve, such as may be used to selectively vent or purge the vapor storage device and/or the fuel tank. The opening of the canister 22 to the air, preferably through the flange 30, can be fitted with a hydrophobic or oleophobic membrane.

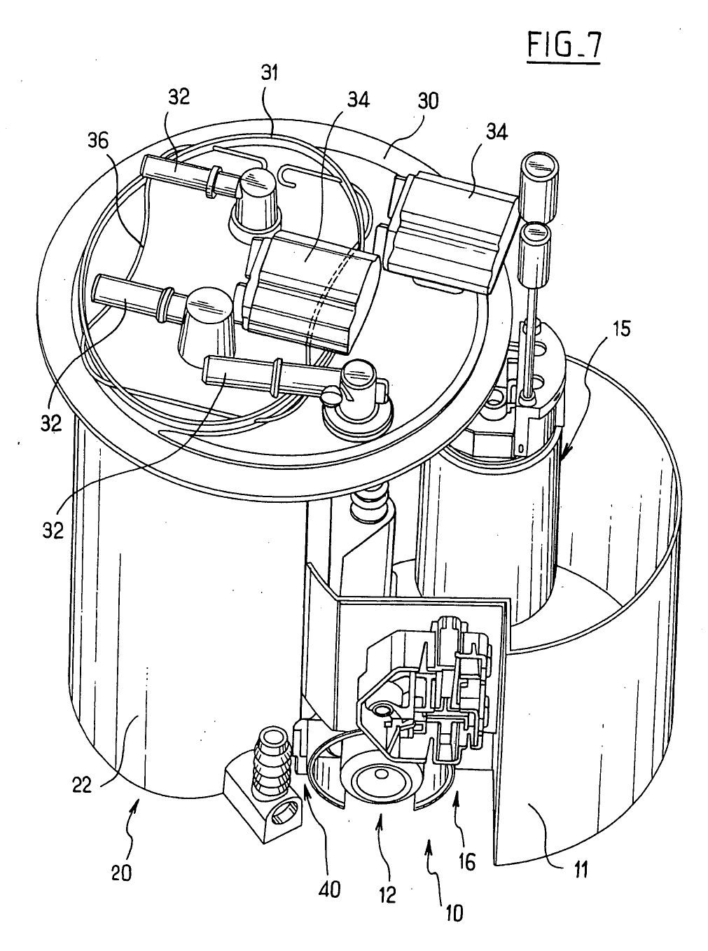

A second implementation of an assembly is shown in FIG. 7, according to which the second component 20 includes a fuel filter without any activated charcoal or other vapor storage or control medium. The general structure of the assembly shown in FIG. 7, corresponds to that of the assembly illustrated in FIGS. 1-6. It will therefore not be described in detail again. Likewise, the elements making up this assembly may be substantially as previously described. They will therefore not be described again in detail.

The pumping assembly 10 includes a reservoir 11 containing an electric pump 15, a pressure regulator 12 and a fuel level gauge 16. The pumping assembly 10 is carried by a canister 22 that carries or encloses the fuel filter by a support 40 like that described previously with reference to FIGS. 1-6. Thus, the reservoir 11 is capable of movement relative to the canister 22 as described above. The filter contained in the canister 22 may be connected, by any appropriate means or mechanism(s), to the electric pump 15 and to fittings carried by and passing through the flange 30 providing appropriate fluid connections to the engine. The filter removes contaminants from fuel before it is pumped to the engine and may be of known construction and arrangement.

The flange 30 may include an access door 34 through which access may be gained to the fuel filter to permit replacement of the latter. The door 34 may be secured to the flange 30 such as by a resilient and flexible wire or clip 36. The clip may be formed, as shown in FIG. 7, of a loop in the general shape of an open “C”, created using metal wire. At rest, the clip 36 interferes firstly with a wall 31 projecting from the upper surface of the flange 30 around the door 34, and more particularly with windows or slots created in this wall 31, and secondly with the upper surface of the door 34. To release the door 34, it suffices to deform the clip 36 elastically, so that it is released from the wall 31. When filter replacement has been completed, the door 34 and the clip 36 can be re-positioned without difficulty. Of course, the door may be releasably closed by any suitable means or mechanism(s) which may or may not include a clip as shown.

1. An assembly including components received at least in part in a fuel tank, comprising:
a first component disposed in the fuel tank;
a second component disposed in the fuel tank;
a connection feature interconnecting the first component and the second component to permit relative movement between them to facilitate insertion of both the first component and the second component into the fuel tank.

2. The assembly of claim 1 wherein the first component includes a fuel pumping assembly that has a fuel pump and a reservoir which carries the fuel pump and is connected to the second component by the connection feature.

3. The assembly of claim 1 wherein the connection feature permits slidable movement between the first component and the second component.

4. The assembly of claim 1 wherein the fuel tank includes an opening through which the second component is inserted into the fuel tank and the second component has a height that is substantially equal to the height of the fuel tank in the area of the opening.

5. The assembly of claim 4 wherein the second component has a lateral sectional surface area that is substantially equal to the area bounded by the opening.

6. The assembly of claim 1 wherein the connection feature includes two elements capable of movement relative to each other with one element being connected to the first component and the other element being connected to the second component.

7. The assembly of claim 6 wherein said one element and said other element move relative to each other in substantially the same direction in which the first component and second component are inserted into the fuel tank.

8. The assembly of claim 1 which also includes a flange and wherein the fuel tank includes an opening through which the second component is inserted into the fuel tank, the flange covers the opening and is connected to the fuel tank, and the second component is carried by the flange.

9. The assembly of claim 8 wherein the second component is connected directly to the flange.

10. The assembly of claim 2 wherein the reservoir includes a chamber capable of storing a supply of fuel communicated with the fuel pump.

11. The assembly of claim 2 which also comprises a fuel level sensing device carried by at least one of the first component or the second component.

12. The assembly of claim 1 wherein the second component includes a mass of activated carbon.

13. The assembly of claim 12 which also includes a vapor circuit communicating the second component with an engine to permit fuel vapors in the second component to be vented to the engine.

14. The assembly of claim 13 wherein the vapor circuit includes an air intake through which air flows to promote the flow of vapor out of the second component.

15. The assembly of claim 1 which also includes a biasing member carried by the second component and yieldably biasing the first component toward a lower wall of the fuel tank.

16. The assembly of claim 6 wherein the connection feature includes a biasing member that yieldably biases the elements to an extended position.

17. A fuel system assembly including components received at least partially in a fuel tank, comprising:
a fuel pump assembly including a reservoir in which a supply of fuel may be received, a fuel pump having an inlet in communication with the reservoir;
a flange which carries the fuel pump assembly and is adapted to be secured to the fuel tank; and
a vapor canister connected to the fuel pump module for movement of at least one of the vapor canister and fuel pump relative to the other, the vapor canister being adapted to at least temporarily store fuel vapors therein and being carried by the flange and disposed in the fuel tank.

18. The fuel system assembly of claim 17 wherein the fuel pump is carried by the reservoir and the reservoir is connected to the vapor canister for movement relative to the vapor canister and the flange.

19. The fuel system assembly of claim 18 wherein the reservoir is moveable relative to the vapor canister in substantially the same direction as the direction in which the reservoir is inserted into the fuel tank.

20. A method of installing an assembly into a fuel tank through an opening in the fuel tank wherein the assembly has a first component, a second component connected to the first component, and a flange, the method comprising the steps of:
inserting at least a portion of the first component into the fuel tank with the assembly in an extended position;
laterally moving the assembly relative to the fuel tank so that the first component is moved laterally relative to the opening and the second component is positioned for insertion into the fuel tank;
moving the assembly to its retracted position by displacing the second component relative to the first component in a direction substantially parallel to an axis of the opening to thereby insert at least a portion of the second component into the fuel tank; and
connecting the flange to the fuel tank.
